(19) United States
(12) Patent Application Publication
(10) Pub. No.: US 2024/0425425 A1
(43) Pub. Date: Dec. 26, 2024

(54) ENHANCING DISSOLUTION OF SPARINGLY SOLUBLE SALTS

(71) Applicant: ICL EUROPE COOPERATIEF U.A., Amsterdam (NL)

(72) Inventors: Khalil ABU-RABEAH, Beer Sheva (IL); Ruth FRIED, Kfar Haro'e (IL)

(21) Appl. No.: 18/701,267

(22) PCT Filed: Oct. 10, 2022
(86) PCT No.: PCT/IL2022/051077

§ 371 Date: Apr. 15, 2024

Related U.S. Application Data
(60) Provisional application No. 63/270,944, filed on Oct. 22, 2021.

(51) Int. Cl. C05D 1/02; C05G 3/40; C05G 5/12

(52) U.S. Cl. CPC C05D 1/02; C05G 3/44; C05G 5/12

(57) ABSTRACT

According to some embodiments, there is provided herein a composition for enhancing the dissolution of a low soluble fertilizer comprising one or more materials creating a stearic interference in the spatial arrangement of said fertilizer when dissolved in water, wherein said one or more materials is selected from the group including: Seaweed, Polynaphthalene sulfonate or alginic acid.

### FIELD OF THE INVENTION

The present invention relates to the field of fertilizers, specifically to the enhancement of the dissolution of fertilizer salts.

### BACKGROUND OF THE INVENTION

To grow properly, plants need nutrients (nitrogen, potassium, calcium, zinc, magnesium, iron, manganese, etc.) which normally can be found in the soil. Sometimes fertilizers are needed to achieve a desired plant growth as these can enhance the growth of plants.

This growth of plants is met in two ways, the traditional one being additives that provide nutrients. The second mode by which some fertilizers act is to enhance the effectiveness of the soil by modifying its water retention and aeration. Fertilizers typically provide, in varying proportions, three main macronutrients:
Nitrogen (N): leaf growth;
Phosphorus (P): Development of roots, flowers, seeds, fruit;
Potassium (K): Strong stem growth, movement of water in plants,
promotion of flowering and fruiting;
three secondary macronutrients: calcium (Ca), magnesium (Mg), and Sulphur(S); and
other micronutrients: copper (Cu), iron (Fe), manganese (Mn), molybdenum (Mo), zinc (Zn), boron (B), and of occasional significance there are silicon (Si), cobalt (Co), and vanadium (V) plus rare mineral catalysts.

The most reliable and effective way to make the availability of nutrients coincide with plant requirements is by controlling their release into the soil solution, using slow release or controlled release fertilizers.

However, many mineral fertilizer, especially sulphate minerals, e.g., Polyhalite, are not easily dissolved and thus disintegrating agents may be used.

The mechanism of a disintegrated agent is not fully understood but most of the disintegrates can swell more than 10-20 time their own weight. It was suggested that the aqueous medium may enter the pores of the disintegrant and enter by capillary forces into the microstructure of the tablet thereby enhancing the dissolution thereof.

Nonetheless, there still remains a need for a solution to enhance the dissolution of sparingly soluble salts, such as mineral salts, in order to increase the effectiveness of their use, e.g., as fertilizers.

### SUMMARY OF THE INVENTION

According to some demonstrative embodiments, there is provided herein a composition for enhancing the dissolution of a low soluble fertilizer comprising one or more materials obstructing the stearic configuration of said low soluble fertilizer.

According to some demonstrative embodiments, there is provided herein a composition for enhancing the dissolution of a low soluble fertilizer comprising one or more materials selected from the group including: Seaweed, Polynaphthalene sulfonate or alginic acid.

According to some embodiments, the fertilizer may be selected from the group including Anhydrite (anhydrous calcium sulfate), Synginite, Polyhalite, Gypsum, Kieserite, Epsomite, Glauberite, Blodite, Langbeinite, Kainite, Schonite, Calcium sulphate, potassium magnesium and sulfur fertilizers.

According to some embodiments, the fertilizer may preferably be Polyhalite.

According to some embodiments, the Polyhalite may be in granular form having a size of 02-4.75 mm.

According to some embodiments, the Polyhalite may be in powder form having a particle size of less than 2 mm.

According to some embodiments, the one or more materials may be in a concentration of 0.5-6% w/w.

According to some embodiments, the one or more materials may be Polynaphthalene sulfonate in a concentration of 2-4% w/w.

According to some embodiments, the one or more materials may be Seaweed in a concentration of 2-4% w/w.

According to some embodiments, there is provided herein a process for enhancing the dissolution of a fertilizer comprising adding the composition of claim 1 and water to said fertilizer; mixing; and filtrating any undissolved solids.

According to some embodiments, the fertilizer may be selected from the group including Anhydrite, Synginite, Polyhalite, Gypsum, Kieserite, Epsomite, Glauberite, Blodite, Langbeinite, Kainite, Schonite, Calcium sulphate, potassium magnesium and sulfur fertilizers.

According to some embodiments, the fertilizer may preferably be Polyhalite.

### DETAILED DESCRIPTION OF THE INVENTION

According to some demonstrative embodiments, there is provided herein a composition for enhancing the dissolution of a fertilizer, comprising one or more materials creating a stearic interference in the spatial arrangement of the fertilizer when dissolved in water and thus, e.g., diminishing or preventing the possible bonding between components in the fertilizer which form an insoluble material, wherein the one or more materials may be selected from the group including: Seaweed, Polynaphthalene sulfonate and alginic acid.

According to some demonstrative embodiments, there is provided herein a composition for enhancing the dissolution of a fertilizer, comprising one or more materials selected from the group including: Seaweed, Polynaphthalene sulfonate and alginic acid.

According to some embodiments, the composition of the present invention may be specifically useful in enhancing the dissolution of mineral salts, including for example, Anhydrite, Synginite, Polyhalite, Gypsum, Kieserite, Epsomite, Glauberite, Blodite, Langbeinite, Kainite, Schonite, Calcium sulphate, potassium magnesium and sulfur fertilizers (e.g., K-Mag®) and the like.

According to some embodiments, the fertilizer may be a sparingly soluble mineral salt, having a low solubility of including, for example, Polyhalite.

According to some embodiments, most of the liquid fertilizers, whether in solutions, suspensions and the like, are composed of soluble salts, and in the case of fertilizers, can be used for foliar spraying. However, many mineral salts, for example, such as the salts listed hereinabove, may possess low solubility and as such, the use thereof in a suspension purposes is extremely challenging as spraying nozzle will clog up or congest.

According to some embodiments, the effectively dissolving the sparingly soluble salts described herein may allow for the formation of a suspension, which can be effectively spread on a crop (unlike powder or granular fertilizers which tend to spread ununiformly).

According to some embodiments, the composition of the present invention may be added to a fertilizer in granular or powder form, and may prevent the formation of sedimentation during the dissolvement of the fertilizer spread on a soil. For example, when polyhalite is used in granular or powder for as a fertilizer, a gypsum sediment may appear after a while. According to some embodiments, the use of the composition of the present invention may overcome this problem by enhancing the dissolution of the polyhalite and leave little to no gypsum traces at all.

According to these embodiments, the existence of the mineral salt fertilizer, e.g., polyhalite, in the form of a dissolved liquid, e.g., a suspension may allow for the effective mixing and/or combination with other substances, including, for example, Bio stimulants, Micro-organisms, Organic fertilizers and the like.

According to some other embodiments, there is provided herein a use of a composition, comprising one or more materials selected from the group including: Seaweed, Polynaphthalene sulfonate and alginic acid, for enhancing the dissolution of a mineral salt fertilizer, wherein the use comprises mixing 0.5-6% w/w of the at least one or more materials with the mineral salt fertilizer.

According to some preferred embodiments, the mineral salt fertilizer may preferably be Polyhalite. Polyhalite is an evaporite mineral, a hydrated sulfate of potassium, calcium and magnesium with formula: K₂Ca₂Mg(SO₄)₄·2H₂O. According to some embodiments, Polyhalite may be used as a fertilizer since it contains four important nutrients and is low in chloride:
48% SO3 as sulfate
14% K2O
6% MgO
17% CaO

The solubility of the polyhalite is low. In some cases this can be obstacle for using polyhalite as a fertilizer, or to produce K₂SO₄ from polyhalite.

In Dissolving of polyhalite three solubility curves can be identified:
Ca+2, Mg+2, K+.

The dissolution mechanism is complicated and a low dissolving compound such as syngenite or gypsum can precipitate during the process.

According to some embodiments, there is provided herein a seaweed composition for enhancing the dissolution of a mineral salt fertilizer, e.g., a sparingly soluble mineral salt fertilizer. According to some embodiments, the seaweed composition allows for the dissolvement of the fertilizer in at least 80% w/w, preferably at least 85% w/w, most preferably at least 90% w/w.

According to some demonstrative embodiments, the term “Seaweed” as used herein may refer to any suitable macroalgae, whether macroscopic, multicellular or marine algae, which may include Rhodophyta (red), Phaeophyta (brown) and Chlorophyta (green) macroalgae.

According to some embodiments, the composition may include Seaweed in a concentration of between 0.5-6% w/w preferably 1-5% w/w, and most preferably 2-4% w/w.

According to some embodiments, there is provided herein a composition comprising a sparingly soluble fertilizer and Seaweed.

According to some embodiments, the seaweed composition of the present invention may enhance the dissolution of Polyhalite, for example, in granular form (2-4.7 mm) and/or in powder form (−2 mm).

According to some demonstrative embodiments, there is provided herein a process for enhancing the dissolution of a fertilizer, including mixing the fertilizer with a seaweed composition.

According to some demonstrative embodiments, and as shown in the examples hereinbelow, 80-100% of the dissolution occurs in the first 5 hours after mixing the seaweed composition of the present invention with the fertilizer salt.

According to some embodiments, there is provided herein a Polynaphthalene sulfonate composition for enhancing the dissolution of a mineral salt fertilizer, e.g., a sparingly soluble mineral salt fertilizer. According to some embodiments, the Polynaphthalene sulfonate composition allows for the dissolvement of the fertilizer in at least 80% w/w, preferably at least 85% w/w, most preferably at least 90% w/w.

According to some embodiments, the composition may include Polynaphthalene sulfonate in a concentration of between 0.5-6% w/w preferably 1-5% w/w, and most preferably 2-4% w/w.

According to some embodiments, there is provided herein a composition comprising a sparingly soluble fertilizer and Polynaphthalene sulfonate.

According to some embodiments, the Polynaphthalene sulfonate composition of the present invention may enhance the dissolution of Polyhalite, for example, in granular form (2-4.7 mm) and/or in powder form (−2 mm).

According to some demonstrative embodiments, there is provided herein a process for enhancing the dissolution of a fertilizer, including mixing the fertilizer with a Polynaphthalene sulfonate composition.

According to some demonstrative embodiments, and as shown in the examples hereinbelow, 80-100% of the dissolution occurs in the first 5 hours after mixing the Polynaphthalene sulfonate composition with the fertilizer salt, e.g., polyhalite.

According to some embodiments, there is provided herein an alginic acid composition for enhancing the dissolution of a mineral salt fertilizer, e.g., a sparingly soluble mineral salt fertilizer. According to some embodiments, the alginic acid composition allows for the dissolvement of the fertilizer in at least 70% w/w, preferably at least 75% w/w. According to some embodiments, the composition may include alginic acid in a concentration of between 0.5-6% w/w preferably 1-5% w/w, and most preferably 2-4% w/w.

According to some embodiments, there is provided herein a composition comprising a sparingly soluble fertilizer and alginic acid.

According to some embodiments, the alginic acid composition of the present invention may enhance the dissolution of Polyhalite, for example, in granular form (2-4.7 mm) and/or in powder form (−2 mm).

According to some demonstrative embodiments, there is provided herein a process for enhancing the dissolution of a fertilizer, including mixing the fertilizer with an alginic acid composition.

According to some demonstrative embodiments, and as shown in the examples hereinbelow, 80-100% of the dissolution occurs in the first 5 hours after mixing the composition of the present invention with the fertilizer salt.

According to some demonstrative embodiments, there is provided herein a composition for enhancing the dissolution of a fertilizer, comprising one or more materials selected from the group including: Seaweed, Polynaphthalene sulfonate and alginic acid.

According to some embodiments, the one or more materials may enhance the dissolvement of the mineral salt fertilizer by absorbing the calcium and preventing the formation or precipitation of gypsum and/or by creating a stearic interference in the spatial arrangement, and thus diminishing or preventing the possible bonding between calcium and sulphate.

According to some demonstrative embodiments, there is provided herein a composition for enhancing the dissolution of a fertilizer, comprising two or more materials selected from the group including: Seaweed, Polynaphthalene sulfonate and alginic acid.

According to some embodiments, the use of two or more materials may provide a synergistic effect.

### EXAMPLES

### Procedure

Samples of polyhalite granular or powder were dissolved in 990 ml of water for 24 hours to determine base solubility, samples were taken from time to time. After 24 hours the sample was filtrated. The solution and the solid were analyzed, and the percent of the dissolved components was calculated.

The % of dissolved component was calculated from the solid analysis according to the assumption that all the solid was dissolved.

### Experiments

### Experiment 1

10 gr of granular polyhalite was dissolved in 990 ml water (Solution PH=7.4) for 24 hours.

The analysis of the solution as a function of time is detailed in table 1:

TABLE 1

| Time | CaO | MgO | K₂O | SO₄ |
|---|---|---|---|---|
| (h) | (ppm) | (ppm) | (ppm) | (ppm) |
| 0.25 | 755 | 295 | 742 | 3200 |
| 0.5 | 933 | 366 | 894 | 3900 |
| 1 | 893 | 451 | 1070 | 4200 |
| 2 | 683 | 531 | 1200 | 4200 |
| 3 | 690 | 599 | 1400 | 4700 |
| 4 | 879 | 567 | 1300 | 4900 |
| 5 | 734 | 608 | 1400 | 4900 |
| 24 | 592 | 571 | 1400 | 4500 |

The % of dissolved component is detailed in table 2 below:

TABLE 2

| | CaO | MgO | K₂O | SO₄ |
|---|---|---|---|---|
| | (ppm) | (ppm) | (ppm) | (ppm) |
| Calculated | 1890 | 666 | 1370 | 6400 |
| % dissolved | 31.32% | 85.73% | 100.00% | 70.31% |

Remained undissolved solid 3.2 gr

The analysis of any remained undissolved solids is detailed in table 3:

TABLE 3

| CaO (%) | MgO (%) | K₂O (%) | SO₄ (%) |
|---|---|---|---|
| 26.2 | 1.19 | 0.11 | 60.4 |

### Experiment 2

As in experiment 1, but 2% seaweed was added.

The analysis of the solution (Solution PH=6.29) as a function of time is detailed in table 4 below:

TABLE 4

| Time | CaO | MgO | K₂O | SO₄ |
|---|---|---|---|---|
| (h) | (ppm) | (ppm) | (ppm) | (ppm) |
| 0.25 | 569 | 217 | 542 | 2200 |
| 0.5 | 803 | 298 | 713 | 3100 |
| 1 | 1024 | 385 | 893 | 3900 |
| 2 | 1228 | 449 | 1055 | 4700 |
| 3 | 1300 | 481 | 1119 | 5200 |
| 4 | 1400 | 539 | 1200 | 5600 |
| 5 | 1500 | 562 | 1200 | 5800 |
| 24 | 1500 | 599 | 1300 | 6000 |

% of the dissolved components is detailed in table 5 below:

TABLE 5

| | CaO | MgO | K₂O | SO₄ |
|---|---|---|---|---|
| | (ppm) | (ppm) | (ppm) | (ppm) |
| Calculated | 1830 | 638 | 1370 | 6240 |
| % dissolved | 81.96% | 93.88% | 94.89% | 96.15% |

Remaining undissolved solid 0.89 gr

Analysis of the remained undissolved solid is detailed in table 6:

TABLE 6

| CaO (%) | MgO (%) | K₂O (%) | SO₄ (%) |
|---|---|---|---|
| 27.6 | 3.74 | 0.91 | 66.2 |

### Experiment 3

10 gr of polyhalite powder were dissolved with 2% seaweed in similar conditions as in experiment 1 (Solution PH=6.27)

### Polyhalite Analysis

The analysis of solution as a function of time is detailed in table 7 below:

TABLE 7

| Time | CaO | MgO | K₂O | SO₄ |
|---|---|---|---|---|
| (h) | (ppm) | (ppm) | (ppm) | (ppm) |
| 0.25 | 691 | 250 | 620 | 2290 |
| 0.5 | 798 | 292 | 685 | 2727 |
| 1 | 999 | 369 | 843 | 3396 |
| 2 | 1207 | 444 | 1011 | 4122 |
| 3 | 1346 | 498 | 1298 | 4593 |
| 4 | 1402 | 519 | 1158 | 4802 |
| 5 | 1456 | 538 | 1211 | 4697 |
| 24 | 1368 | 586 | 1298 | 5053 |

% of the dissolved components is detailed in table 8:

TABLE 8

| | CaO | MgO | K₂O | SO₄ |
|---|---|---|---|---|
| | (ppm) | (ppm) | (ppm) | (ppm) |
| Calculated | 1832 | 601 | 1391 | 6076 |
| % dissolved | 74.67% | 97.50% | 93.31% | 83.16% |

Remaining undissolved solid 0.61 g:

Analysis of remained undissolved solid is detailed in table 9:

TABLE 9

| CaO (%) | MgO (%) | K₂O (%) | SO₄ (%) |
|---|---|---|---|
| 32.2 | 5.56 | 0.82 | 58.9 |

### Experiment 4

As experiment 3 with 4% seaweed.

The analysis of solution (Solution PH=6.85) as a function of time is detailed in table 10:

TABLE 10

| | CaO | MgO | K₂O | SO₄ |
|---|---|---|---|---|
| Time (h) | (ppm) | (ppm) | (ppm) | (ppm) |
| 0.25 | 522 | 202 | 504 | 1800 |
| 0.5 | 782 | 305 | 740 | 2700 |
| 1 | 918 | 363 | 878 | 3300 |
| 2 | 1119 | 443 | 1042 | 4100 |
| 3 | 1252 | 496 | 1164 | 4600 |
| 4 | 1273 | 539 | 1240 | 4900 |
| 5 | 1447 | 552 | 1283 | 5100 |
| 24 | 1605 | 602 | 1433 | 5700 |

% of the dissolved components is detailed in table 11:

TABLE 11

| | CaO | MgO | K₂O | SO₄ |
|---|---|---|---|---|
| | (ppm) | (ppm) | (ppm) | (ppm) |
| Calculated | 1795 | 589 | 1363 | 5952 |
| % dissolved | 89.41% | 100.00% | 100.00% | 95.76% |

Remained undissolved solid 0.17 gr

Analysis of remained undissolved solid is detailed in table 12:

TABLE 12

| CaO (%) | MgO (%) | K₂O (%) | SO₄ (%) |
|---|---|---|---|
| 32.1 | 1.43 | 0.11 | 57 |

### Experiment 5

10 gr of granular polyhalite with 2% of disintegrated agent Polynaphthalene sulfonate The analysis of solution as a function of time is detailed in table 13:

TABLE 13

| | CaO | MgO | K₂O | SO₄ |
|---|---|---|---|---|
| Time (h) | (ppm) | (ppm) | (ppm) | (ppm) |
| 0.25 | 637 | 242 | 723 | 2500 |
| 0.5 | 782 | 292 | 703 | 3200 |
| 1 | 1002 | 370 | 846 | 3900 |
| 2 | 1294 | 464 | 1032 | 4900 |
| 3 | 1435 | 526 | 1153 | 5800 |
| 4 | 1389 | 534 | 1172 | 5700 |
| 5 | 1393 | 540 | 1183 | 5700 |
| 24 | 1400 | 608 | 1400 | 6200 |

Solution PH=8.39%

% of dissolved components is detailed in table 14:

TABLE 14

| | CaO | MgO | K₂O | SO₄ |
|---|---|---|---|---|
| | (ppm) | (ppm) | (ppm) | (ppm) |
| calculated | 1750 | 615 | 1350 | 6220 |
| % dissolved | 80.00% | 98.85% | 100.00% | 99.67% |

Remained undissolved solid 0.6 g

Analysis of remained undissolved solid is detailed in table 15:

TABLE 15

| CaO (%) | MgO (%) | K₂O (%) | SO₄ (%) |
|---|---|---|---|
| 26.8 | 2.27 | 2.26 | 64.7 |

### Experiment 6

As experiment 5 with polyhalite powder with 2% disintegrated agent

### Polynaphthalene Sulfonate

The analysis of solution (Solution PH=8.4) as a function of time is detailed in table 16:

TABLE 16

| | CaO | MgO | K₂O | SO₄ |
|---|---|---|---|---|
| Time (h) | (ppm) | (ppm) | (ppm) | (ppm) |
| 0.25 | 577 | 215 | 520 | 2103 |
| 0.5 | 743 | 280 | 618 | 2654 |
| 1 | 924 | 350 | 784 | 3400 |
| 2 | 1070 | 403 | 964 | 4214 |
| 3 | 1320 | 501 | 1089 | 4597 |
| 4 | 1347 | 509 | 1110 | 4921 |
| 5 | 1392 | 532 | 1119 | 5028 |
| 24 | 1402 | 555 | 1207 | 4242* |

% of dissolved components is detailed in table 17:

TABLE 17

| | CaO | MgO | K₂O | SO₄ |
|---|---|---|---|---|
| | (ppm) | (ppm) | (ppm) | (ppm |
| calculated | 1832 | 601 | 1391 | 6076 |
| % dissolved | 76.52% | 92.34% | 86.77% | 69.81% |

Remained undissolved solid 0.91 g

Analysis of remained undissolved solid is detailed in table 18:

TABLE 18

| CaO (%) | MgO (%) | K₂O (%) | SO₄ (%) |
|---|---|---|---|
| 32.1 | 3.87 | 0.19 | 58.2 |

### Experiment 7

As experiment 5 with 2% Alginic acid.

The analysis of solution (Solution PH-5.73) as a function of time is detailed in table 19:

TABLE 19

| | CaO | MgO | K₂O | SO₄ |
|---|---|---|---|---|
| Time (h) | (ppm) | (ppm) | (ppm) | (ppm) |
| 0.25 | 343 | 125 | 335 | 1209 |
| 0.5 | 401 | 144 | 370 | 1400 |
| 1 | 466 | 171 | 425 | 1627 |
| 2 | 505 | 191 | 490 | 1814 |
| 3 | 554 | 215 | 536 | 1995 |
| 4 | 559 | 222 | 545 | 2034 |
| 5 | 595 | 244 | 612 | 2235 |
| 24 | 1070 | 552 | 1289 | 4489 |

% of dissolved components is detailed in table 20:

TABLE 20

| | CaO | MgO | K₂O | SO₄ |
|---|---|---|---|---|
| calculated | 1832 | 601 | 1391 | 6076 |
| % dissolved | 58.40% | 91.84% | 92.66% | 73.88% |

Table 20

Remained undissolved solid 2.5 gr

Analysis of remained undissolved solid is detailed in table 21:

TABLE 21

| CaO (%) | MgO (%) | CI (%) | K₂O (%) | SO₄ (%) |
|---|---|---|---|---|
| 28.4 | 3.86 | 4.65 | 62.1 | 28.4 |

### Experiment 8

In this experiment, different types of seaweeds were tested. Simple seaweed was compared to Wild-harvested premium seaweed (known as Acadian) in powder form.

TABLE 22

| | pH | pH | Remained | Dissolved |
|---|---|---|---|---|
| Sample | (t = 0) | (t = 24 h) | solid (g) | ( %) |
| Poly standard | 7.60 | 7.54 | 3.25 | 67.5 |
| 100% reference | | | | |
| Poly standard | 6.85 | 6.75 | 0.17 | 98.3 |
| 96% + seaweed 4% | | | | |
| Poly standard | 6.61 | 6.52 | 0.15 | 98.5 |
| 96% + Acadian 4% | | | | |

While this invention has been described in terms of some specific examples, many modifications and variations are possible. It is therefore understood that within the scope of the appended claims, the invention may be realized otherwise than as specifically described.

1. A composition for enhancing the dissolution of a low soluble fertilizer comprising one or more materials creating a stearic interference in the spatial arrangement of said fertilizer when dissolved in water, wherein said one or more materials is selected from the group including: Seaweed, Polynaphthalene sulfonate or alginic acid.

2. The composition of claim 1, wherein said fertilizer is selected from the group including Anhydrite, Synginite, Polyhalite, Gypsum, Kieserite, Epsomite, Glauberite, Blodite, Langbeinite, Kainite, Schonite, Calcium sulphate, potassium magnesium and sulfur fertilizers.

3. The composition of claim 1, wherein said fertilizer is Polyhalite.

4. The composition of claim 3, wherein Polyhalite is in granular form having a size of 2-4.75 mm.

5. The composition of claim 3, wherein Polyhalite is in powder form having a particle size of less than 2 mm.

6. The composition of claim 2, wherein said one or more materials is in a concentration of 0.5-6% w/w.

7. The composition of claim 1, wherein said one or more materials is Polynaphthalene sulfonate in a concentration of 2-4% w/w.

8. The composition of claim 1, wherein said one or more materials is Seaweed in a concentration of 2-4% w/w.

9. A process for enhancing the dissolution of a fertilizer comprising adding the composition of claim 1 and water to said fertilizer;
mixing; and
filtrating any undissolved solids.

10. The process of claim 6, wherein said fertilizer is selected from the group including Anhydrite, Synginite, Polyhalite, Gypsum, Kieserite, Epsomite, Glauberite, Blodite, Langbeinite, Kainite, Schonite, Calcium sulphate, potassium magnesium and sulfur fertilizers

11. The process of claim 8, wherein said fertilizer is Polyhalite.

12. The process of claim 9, wherein 80-100% of the dissolution occurs in the first 5 hours after mixing the composition of claim 1 with said fertilizer.
